(19) United States
(12) Patent Application Publication
(10) Pub. No.: US 2022/0180342 A1
(43) Pub. Date: Jun. 9, 2022

(54) METHODS FOR AUTOMATED TRANSACTIONS AT SELF-SERVICE COMPUTING APPARATUSES

(71) Applicant: RAPID CASH ATM LTD., Edmonton (CA)

(72) Inventors: William Eaton, Edmonton (CA); Victor Paquin, St. Albert (CA)

(73) Assignee: RAPID CASH ATM LTD., Edmonton, AB (CA)

(21) Appl. No.: 17/598,182

(22) PCT Filed: Mar. 27, 2020
(86) PCT No.: PCT/CA2020/050402

§ 371 Date: Sep. 24, 2021

Related U.S. Application Data
(60) Provisional application No. 62/824,584, filed on Mar. 27, 2019.

(51) Int. Cl. G06Q 20/18

(52) U.S. Cl. CPC G06Q 20/18

(57) ABSTRACT

Methods for automated transactions at self-service computing apparatuses are provided. In some embodiments, the transaction comprises requesting a user selected transaction type and may further comprise dispensing a monetary amount to the user. In other embodiments, the transaction comprises dispensing a payment from a payer. In other embodiments, the transaction comprises administering the exchange of recyclable material for the value of the recyclable material. In other embodiments, the transaction comprises effecting a purchase of a regulated product from a vendor. In some embodiments, the method comprises verifying the identity of the individual performing the transaction at the self-service computing apparatus using at least one biometric profile.

### RELATED APPLICATION

The present application claims priority to U.S. Provisional Patent Application No. 62/824,584 filed on Mar. 27, 2019, the entire contents of which are incorporated by reference.

### FIELD OF THE DISCLOSURE

The present disclosure relates to methods for automated transactions. More particularly, the present disclosure relates to methods for automated transactions at self-service computing apparatuses.

### BACKGROUND

Self-service computing apparatuses may be used for conducting various automated transactions without the need for a user to visit a brick-and-mortar vendor. For example, an automated teller machine (ATM) is a type of self-service computing apparatus for depositing or withdrawing funds from a financial institution.

However, conventional self-service computing apparatuses may have limited functionality. As a result, only certain steps in the overall transaction may be performed at the apparatus whereas other steps may still require the user to visit the vendor in person. Moreover, conventional apparatuses may only allow a user to conduct one or a small number of transaction types at the same apparatus.

In addition, self-service computing apparatuses may have limited security, which may also limit the types of transactions that may be conducted at such apparatuses. Vendors providing such apparatuses to users may limit the available transaction types to reduce the risk of fraudulent transactions.

Self-service computing apparatuses may also have limited ability to determine a user's eligibility to conduct certain transactions. Vendors providing such apparatuses may therefore also limit the available transaction types to reduce the risk of transactions being conducted by ineligible users.

### SUMMARY

In one aspect, there is provided a method at a self-service computing apparatus comprising a user interface and at least one biometric input device; the method comprising; collecting from a user, via the at least one biometric input device, at least one user biometric profile; attempting to verify the user's identity using the at least one user biometric profile; upon successful verification, receiving from the user, via the user interface: a user selection of a transaction type; a plurality of user transaction worthiness factors; determining a user score by assigning a point value to each one of the plurality of user transaction worthiness factors based on a comparison of the each one of the plurality of user transaction worthiness factors to a respective transaction worthiness criterion; and transmitting a request for the user selected transaction type to at least one vendor via a communication network, the request including the user score.

In some embodiments, attempting to verify the user's identity using the at least one biometric profile comprises determining whether the at least one user biometric profile corresponds to at least one stored user biometric profile in a database.

In some embodiments, the database is located on a remote server and the self-service computing apparatus is in communication with the remote server via the communication network.

In some embodiments, the at least one user biometric profile comprises at least one of: a facial recognition profile, a fingerprint, a palm print, a palm vein profile, an iris recognition profile, a retinal recognition profile, a voice recognition profile, a hand geometry profile, and combinations thereof.

In some embodiments, the at least one biometric device comprises a first biometric device and a second biometric device and collecting the at least one user biometric profile comprises collecting a first user biometric profile and a second user biometric profile.

In some embodiments, the first biometric device comprises a scanning device and collecting the first biometric profile comprises scanning a user provided image, via the scanning device, to capture a first facial recognition profile.

In some embodiments, the user provided image comprises a government issued photo identification card.

In some embodiments, the second biometric device comprises a camera and collecting the second biometric profile comprises capturing a second facial recognition profile of the user via the camera.

In some embodiments, the method further comprises receiving a response from the at least one vendor via the communication network, the response indicating that the user selected transaction type has been approved or denied.

In some embodiments, the method further comprises receiving a response from the at least one vendor comprises receiving a respective response from at least two vendors, each respective response indicating that the user selected transaction type has been approved.

In some embodiments, the method further comprises displaying, via the user interface, at least two transaction approvals and receiving, via the user interface, a user selection of one of the at least two transaction approvals.

In some embodiments, the response indicates that the user selected transaction type has been approved and the response further indicates an approved monetary amount.

In some embodiments, the method further comprises dispensing at least a portion of the approved monetary amount to the user.

In some embodiments, the self-service computing apparatus comprises a cash dispenser and dispensing the at least a portion of the approved monetary amount to the user comprises dispensing cash to the user via the cash dispenser.

In some embodiments, dispensing the at least a portion of the approved monetary amount to the user comprises effecting an electronic funds transfer to a user selected bank account.

In some embodiments, dispensing the at least a portion of the approved monetary amount comprises dispensing cryptocurrency to the user.

In some embodiments, dispensing the at least a portion of the approved amount comprises storing the at least a portion of the approved monetary amount in an account accessible to the user by a mobile application.

In another aspect, there is provided a method at a self-service computing apparatus comprising at least one encoded data reader and a dispensing device; the method comprising: reading, via the at least one encoded data reader, encoded data from a user provided voucher, the encoded data indicating a monetary amount to be dispensed to a user; and dispensing, via the dispensing device, at least a portion of the monetary amount to the user.

In some embodiments, the at least one encoded data reader comprises an RFID reader and the encoded data comprises an RFID tag.

In some embodiments, the at least one encoded data reader comprises a bar code scanner and the encoded data comprises a bar code.

In some embodiments, the dispensing device comprises a cash dispenser and dispensing the at least a portion of the monetary amount to the user comprises dispensing cash to the user via the cash dispenser.

In another aspect, there is provided a method at a self-service computing apparatus comprising a user interface; the method comprising: receiving from a user, via the user interface, a quantity of recyclable material to be submitted by the user to a recycling facility; receiving a message from the recycling facility via a communication network, the message indicating that the quantity of recyclable material has been received by the recycling facility; and sending a message to the user, via the communication network, the message indicating a monetary amount payable the user based on the quantity of recyclable material received by the recycling facility, the message including instructions for receiving the monetary amount.

In some embodiments, the self-service computing apparatus comprises a printing device and the method further comprises printing a receipt indicating the quantity of recyclable material to be submitted by the user to the recycling facility.

In some embodiments, the method further comprises dispensing at least a portion of the monetary amount to the user.

In another aspect, there is provided a method at a self-service computing apparatus comprising a scanning device, at least one biometric input device, and a user interface, the method comprising: scanning, via the scanning device, a government issued identification card of a user, the government issued identification card indicating the user's date of birth; collecting from the user, via the at least one biometric device, at least one biometric profile; attempting to verify at least one of: the user's purchase eligibility based on the user's date of birth; and the user's identity using the at least one biometric profile; upon successful verification, receiving from the user, via the user interface, a user selection of one or more regulated products to be purchased; effecting the purchase of one or more user selected regulated products from a vendor.

In some embodiments, the self-service computing apparatus comprises at least one payment device and effecting the purchase of the one or more user selected regulated products comprises: receiving a payment from the user, via the at least one payment device, for the one or more user selected regulated products; transmitting a request for the one or more user selected regulated products to the vendor, the request including the payment; and receiving a response from the vendor confirming purchase of the one or more user selected regulated products.

In some embodiments, the at least one payment device comprises at least one encoded data reader and receiving the payment comprises reading, via the at least one encoded data reader, encoded data from a user provided voucher, the encoded data indicating a monetary amount.

In some embodiments, the one or more regulated products is a gaming product.

In some embodiments, the method further comprises determining if a user purchased gaming product is a winning gaming product.

In some embodiments, the method further comprises dispensing at least a portion of a won amount of the winning gaming product.

Other aspects and features of the present disclosure will become apparent, to those ordinarily skilled in the art, upon review of the following description of the specific embodiments of the disclosure.

### BRIEF DESCRIPTION OF THE DRAWINGS

Some aspects of the disclosure will now be described in greater detail with reference to the accompanying drawings. In the drawings:

FIG. 1 is a block diagram of an example self-service computing apparatus according to some embodiments;

FIG. 2 is a flowchart of an example method at the self-service computing apparatus of FIG. 1 for requesting a transaction type from a vendor, according to some embodiments;

FIG. 3 is a flowchart of another example method according to some embodiments;

FIG. 4 is a block diagram of another example self-service computing apparatus according to some embodiments;

FIG. 5 is a flowchart of an example method at the self-service computing apparatus of FIG. 4 for dispensing a payment from a payer, according to some embodiments;

FIG. 6 is a flowchart of an example method for administering an exchange of recyclable material for the value of the recyclable material, according to some embodiments;

FIG. 7 is a block diagram of another example self-service computing apparatus according to some embodiments;

FIG. 8 is a flowchart of an example method at the self-service computing apparatus of FIG. 7 for effecting a purchase of a regulated product from a vendor, according to some embodiments;

FIG. 9 is a flowchart of an example method showing additional details regarding how the purchase of the regulated product may be effected in some embodiments;

FIG. 10 is a flowchart of another example method, according to some embodiments;

FIG. 11A is an example of a screen displayed by a user interface of the self-service computing apparatus of FIG. 7, according to some embodiments;

FIG. 11B is another example of a screen displayed by a user interface of the self-service computing apparatus of FIG. 7, according to some embodiments;

FIG. 12 is a flowchart of an example method showing additional steps for administering a gaming product prize, according to some embodiments;

FIG. 13 is a front view of a self-service computing apparatus according to some embodiments;

FIG. 14 is a perspective view of the self-service computing apparatus of FIG. 13;

FIG. 15 is an enlarged, partial, perspective view of the interior of the upper section of the self-service computing apparatus of FIG. 13; and

FIG. 16 is an enlarged, partial, perspective view of the interior of the lower section of the self-service computing apparatus of FIG. 13.

### DETAILED DESCRIPTION OF THE EMBODIMENTS

Generally, the present disclosure provides methods for automated transactions at self-service computing apparatuses. In some embodiments, the transaction comprises a financial transaction. In some embodiments, the financial transaction comprises requesting a transaction type from a vendor. In some embodiments, the financial transaction comprises dispensing a payment from a payer. In other embodiments, the transaction comprises administering an exchange of recyclable material for the value of the recyclable material. In other embodiments, the transaction comprises effecting a purchase of a regulated product from a vendor. In some embodiments, the method comprises verifying the identity of the individual performing the transaction at the self-service computing apparatus using at least one biometric profile.

As used herein and in the appended claims, the singular forms “a”, “an”, and “the” include plural referents unless the context clearly dictates otherwise.

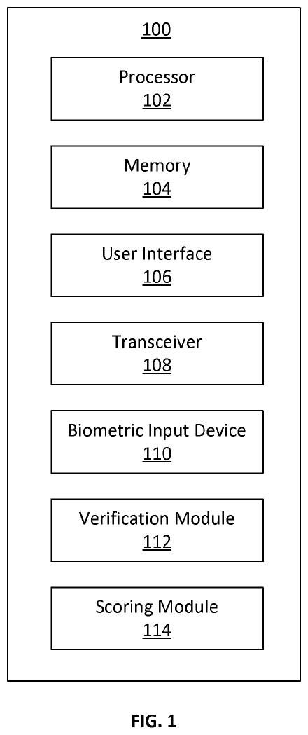

FIG. 1 shows a block diagram of an example self-service computing apparatus 100 according to some embodiments that may implement one or more methods described herein. The self-service computing apparatus 100 includes a processor 102, a memory 104, a user interface 106, a transceiver 108, a biometric input device 110, a verification module 112, and a scoring module 114.

The memory 104 is operatively connected to the processor 102. The memory 104 may store processor-executable instructions therein that, when executed, cause the processor 102 to implement one or more methods described herein. The memory 104 may comprise at least one of a primary storage and a secondary storage.

The user interface 106 may be configured to display information to a user and receive user input. As used herein, a “user” refers to any individual who uses the self-service computing apparatuses described herein. The user interface may comprise at least one input component and at least one output component. The input component may comprise, for example, at least one of a touchscreen a keyboard, a keypad, a mouse, a trackball, a stylus, a navigation pad, a voice input device, or any other suitable type of input device. In some embodiments, the user interface 106 maybe configured to receive input from a user electronic device. The user electronic device may be, for example, a smart phone or tablet. In some embodiments, the user interface 106 maybe configured to receive input from the user electronic device via at least one of a Radio-Frequency Identification (RFID) or a Near Field Communication (NFC) link. In some embodiments, the user interface 106 may be configured to receive input from the user electronic device via a mobile application installed on the user electronic device. The output component may comprise, for example, at least one of a display screen, a projector, a voice output device, or any others suitable type of output device. In some embodiments, the user interface 106 comprises a combined display and input component, such as a touchscreen. The user interface 106 may be operatively connected to the processor 102. The processor 102 may be configured to receive input from a user via the user interface 106 and display output to the user via the user interface 106.

The transceiver 108 may be configured to send and receive communications over a communication network such as the Internet. In some embodiments, the communication network may be a secure network. The communication network may comprise a wired or a wireless network. In some embodiments, the transceiver 108 comprises both a transmitter and a receiver sharing common circuitry. In other embodiments, the transceiver 108 comprises a separate transmitter and receiver.

At least one biometric input device 110 may be configured to collect at least one biometric profile. The biometric input device 110 may be operatively connected to the processor 102 and the processor 102 may be configured to receive and process biometric data from the biometric input device 110. The biometric input device 110 may be configured to collect at least one of: a facial recognition profile; a fingerprint; a palm print; a palm vein profile; an iris recognition profile; a retinal recognition profile; a voice recognition profile; a hand geometry profile; and any other suitable type of biometric profile. The biometric input device 110 may comprise at least one of: a camera; a scanning device; a fingerprint sensor; a palm print or palm vein scanner; an eye scanner; a voice input device; a hand geometry reading device; and any other suitable type of biometric device.

The verification module 112 may verify a user's identify using at least one biometric profile collected by the biometric input device 110. For example, the verification module 112 may verify the user's identity by determining whether a user facial recognition image corresponds to a stored facial recognition image in a database or by determining whether a first user facial recognition profile corresponds to a second user facial recognition profile, as described in more detail below.

The scoring module 114 may determine a user score for a user. In some embodiments, the scoring module 114 determines the user score based on information received from the user via the user interface 106. For example, the scoring module 114 may determine a user score by assigning a point value to a plurality of user transaction worthiness factors based on a comparison of each user transaction worthiness factor to a respective transaction worthiness criterion.

Optionally, the self-service computing apparatus 100 may comprise a dispensing device (not shown). The dispensing device may be configured to dispense a monetary amount to the user. In some embodiments, the dispensing device comprises a cash dispenser. The cash dispenser may comprise at least one of a banknote dispenser and a coin dispenser. In some embodiments, the dispensing device comprises a card dispenser. The card dispenser may be configured to encode a monetary amount on a payment card. The payment card may be, for example, a magnetic stripe card similar to a prepaid debit card. In some embodiments, the dispensing device comprises a printing device configured to print a QR code on a suitable medium, the QR code scannable by a user electronic device, for example, a user smartphone or tablet.

In other embodiments, the dispensing device comprises a dispensing module. In some embodiments, the dispensing module is configured to effect an electronic funds transfer. In some embodiments, the dispensing module is configured to dispense cryptocurrency. In some embodiments, the dispensing module is configured to display a QR code, via the user interface 106, the QR code scannable by a user's electronic device. In some embodiments, the dispensing module is configured to store a monetary amount in an account accessible to the user via a mobile application.

Each of the verification module 112, the scoring module 114, and the optional dispensing module may be implemented as a processor (such as the processor 102) configured to perform the functions described above. Each module may be implemented as a memory (such as the memory 104) containing instructions for execution by a processor (such as the processor 102), by hardware, or by a combination of instructions stored in a memory and additional hardware, to name a few examples. The memory 104 may be internal to the processor 102.

Optionally, the self-service computing apparatus 100 may comprise at least one payment device (not shown). In some embodiments, the payment device comprises a card reader. The card reader may be a magnetic card reader to read a magnetic stripe card, for example, a debit card or a credit card. In some embodiments, the payment device comprises a contactless payment device. In some embodiments, the contactless payment device comprises a Radio Frequency Identification (RFID) or Near Field Communication (NFC) reader. In other embodiments, the contactless payment device comprises a bar code scanner. In some embodiments, the payment device comprises a cash acceptor. The cash acceptor may comprise at least one of a banknote acceptor and a coin acceptor.

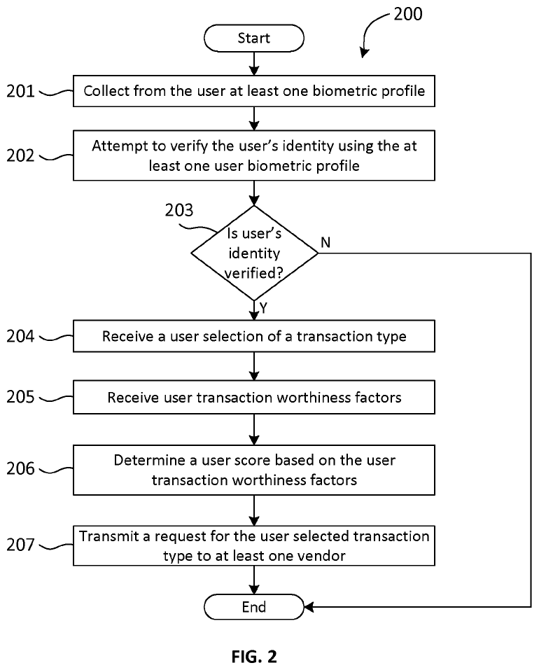

FIG. 2 shows a flowchart of an example method 200 at self-service computing apparatus 100 for requesting a transaction type from a vendor, according to some embodiments.

In some embodiments, the transaction type comprises issuing a credit product. As used herein, “credit product” refers to a sum of money lent to one or more individuals by a vendor, the sum of money being at least partially repayable to the vendor. In some embodiments the credit product is repayable with interest at an interest rate determined by the vendor. In some embodiments, the credit product may comprise at least one of a loan, a line of credit, a mortgage, an overdraft protection, and combinations thereof. The loan may comprise at least one of an asset loan, a term loan, a payday loan, an unsecured loan, a student loan, an automobile loan, and combinations thereof. However, the person skilled in the art will recognize that any type of credit product may be requested using the methods disclosed herein and the disclosed methods are not limited by the type of credit product to be requested.

In some embodiments, the vendor is a lending institution. As used herein, “lending institution” refers to a financial institution that issues at least one credit product. For example, the lending institution may be a bank, a savings institution, a credit union, a finance company, or a mortgage company. In other embodiments, the vendor may be any other suitable vendor.

In this embodiment, the user of the self-service computing apparatus 100 is an individual desirous of requesting at least one transaction type. The user may engage the self-service computing apparatus 100 to start a new user session. As used herein “user session” refers to at least one user action over a discrete period of time.

In FIG. 2, at block 201, the self-service computing apparatus 100 collects at least one user biometric profile from the user. The user biometric profile may comprise at least one of a facial recognition profile, a fingerprint, a palm print, a palm vein profile, an iris recognition profile, a retinal recognition profile, a voice recognition profile, a hand geometry profile, and combinations thereof.

In some embodiments, a facial recognition profile is collected from the user. In some embodiments, at least one biometric device 110 comprises a camera and the camera takes a photograph of the user to capture the facial recognition profile. In some embodiments, the photograph is a high resolution photograph. The facial recognition profile may be stored in the memory 104.

At block 202, the self-service computing apparatus 100 attempts to verify the user's identity using at least one user biometric profile. In some embodiments, attempting to verify the user's identity comprises determining whether at least one user biometric profile corresponds to a stored user biometric profile in a database. In some embodiments, the facial recognition profile, fingerprint, palm print, palm vein profile, iris recognition profile, retinal recognition profile, voice recognition profile, hand geometry profile, or combination thereof, is compared to a stored facial recognition profile, fingerprint, palm print, palm vein profile, iris recognition profile, retinal recognition profile, voice recognition profile, or hand geometry profile, or combination thereof. In some embodiments, the database is located on a remote server and the processor 102 is in communication with the remote server via the communication network. In some embodiments, the self-service computing apparatus 100 makes an API (Application Program Interface) call to the remote database.

At block 203, if the user biometric profile corresponds to a stored user biometric profile, the user's identity is verified (yes branch block 203) and the method 200 may proceed to block 204. If the user biometric profile does not correspond to a stored user biometric profile in the database, the user's identity is not verified (no branch block 203), and the user session may be terminated. In some embodiments, the user interface 106 returns to a main menu screen.

In the example method 200 shown in FIG. 2, the user's identity is verified prior to receiving a user selection of the transaction type; however, in other embodiments, the user's identity may be verified after receiving a user selection of the transaction type or at any time before the transaction type is approved.

At block 204, the self-service computing apparatus 100 may receive, via the user interface 106, a user selection of a transaction type that the user is desirous of requesting. In some embodiments, the user interface 106 may display a plurality of transaction types to the user for selection. In some embodiments, the user selection includes a selection of a monetary amount of the user selected transaction type that the user is desirous of requesting.

In some embodiments, the self-service computing apparatus 100 also receives a plurality of user identification details from the user (not shown). The plurality of user identification details may be received from the user in a plurality of respective fields displayed to the user via the user interface 106. The user identification details may comprise at least one of the user's name, date of birth, address, phone number, email address, and/or any other relevant details. In some embodiments, at least one user identification detail is received from the user via the user interface 106. In some embodiments, the self-service computing apparatus 100 comprises a scanning device and at least one user identification detail is received by scanning a government issued identification (ID) card of the user via the scanning device. The user's government issued ID card may comprise, for example, a driver's license, a passport, a health care card, a national identity card, or any other government issued ID card containing user identification details.

In some embodiments, if the user is a new user, the user may be prompted, via the user interface 106, to select a user name and a password. As used herein “new user” is a user who has not used the self-service computing apparatus 100 prior to the current user session. The user selected user name and password, along with the user identification details, may be stored as a user profile in the memory 104.

In some embodiments, if the user is a returning user, the user may be prompted, via the user interface 106, to enter their selected user name and password. As used herein “returning user” is a user who has used the self-service computing apparatus 100 at least once prior to the current user session. The stored user profile may then be retrieved from the memory 104 and displayed to the user via the user interface 106. The user may be prompted, via the user interface 106, to confirm their identification details and update their identification details if one or more of their identification details have changed. In some embodiments, if the user's biometric profile matches a stored biometric profile in a database, the self-service computing apparatus 100 recognizes that the user is a returning user and retrieves the user's profile without requiring the user to enter their user name and password. In other embodiments, after scanning the user's government issued ID card, the self-service computing apparatus 100 recognizes that the user is a returning user and retrieves the user's profile without requiring the user to enter their user name and password.

In other embodiments, the user is prompted, via the user interface 106, to enter their selected user name and password, or select a new user name and password, prior to verification of the user's identity as described above.

At block 205, the self-service computing apparatus 100 receives, via the user interface 106, a plurality of user transaction worthiness factors. The plurality of user transaction worthiness factors may be received from the user in a plurality of respective fields displayed to the user via the user interface 106. As used herein “transaction worthiness factors” refers to information relevant to approval of the user selected transaction type by a vendor. For example, where the transaction type comprises issuing a credit product, the transaction worthiness factors (or “credit worthiness factors”) may be information relevant to the user's ability to repay the credit product. In some embodiments, the user transaction worthiness factors may comprise at least one of the user's: marital status; date of birth; income; employer's name and contact information; years of employment at an employer; social insurance number; residency (e.g. ownership vs. renting); expenses such as residential expenses (e.g. rent or mortgage payments) and other expenses (e.g. alimony), assets including bank accounts, investments, vehicles, real estate, and any other relevant asset; and liabilities including car payments, loans, credit card debt, and any other relevant liabilities. In some embodiments, the user transaction worthiness factors may comprise any other information relevant to approval of the user selected transaction type by a vendor. In some embodiments, at least one user transaction worthiness factor may further comprise information related to a co-applicant. As used herein, “co-applicant” refers to an additional individual for whom the transaction type is to be requested along with the user. The co-applicant information may comprise at least one of the co-applicant's: social insurance number; date of birth; income; employer's name and contact information; and any other relevant information of the co-applicant.

In some embodiments, the plurality of user transaction worthiness factors received from the user are stored as part of the user profile of the user.

In some embodiments, if the user's assets include at least one bank account, the self-service computing apparatus 100 verifies the bank account information of the user. In some embodiments, the user bank account information comprises at least one of a bank account number, a name and address of the financial institution at which the bank account is held, and an account value. In some embodiments, verifying the user bank account information comprises transmitting the user bank account information to a third party verification service via the communication network and receiving a response from the third party verification service verifying the user bank account information. In some embodiments, the third party verification service is Inverite Verification Inc.™ or any other entity providing a similar service.

At block 206, the self-service computing apparatus 100 determines a user score, by assigning a point value to each user transaction worthiness factor. The point value for each user transaction worthiness factor may be based on a comparison of each user transaction worthiness factor to a respective transaction worthiness criterion For example, where the user's years of employment at an employer is used as a user transaction worthiness factor: employment of less than 0.5 years may receive zero points, employment of 0.5 to 1 year may receive 1 point, employment of 1 to 2 years may receive 2 points, employment of 2 to 3 years may receive 3 points, and so on. In some embodiments, each point value may have a respective weighting. In some embodiments, at least one point value may have a different weighting than at least one other point value. Therefore, in some embodiments, the weighted point values are used to determine the user score.

At block 207, the self-service computing apparatus 100 transmits a request for the user selected transaction type to at least one vendor via the communication network. The request may include the user score. In some embodiments, the request is encrypted and an encrypted request is transmitted to at least one vendor.

In some embodiments, a threshold score provided by at least one vendor is stored in the memory 104. In some embodiments, the scoring module 114 compares the user score to the threshold score. If the user score is at or above the threshold score for a given vendor, the request for the user selected transaction type may be transmitted to that vendor. If the user score is below the threshold score for a given vendor, the request may not be transmitted to that vendor.

In some embodiments, the user score may be used by at least one vendor to approve or deny the user selected transaction type as described below. In other embodiments, the user score may be used by at least one vendor to determine at least one of an approved monetary amount, an interest rate, a transaction term, and/or any other factor relevant to the transaction.

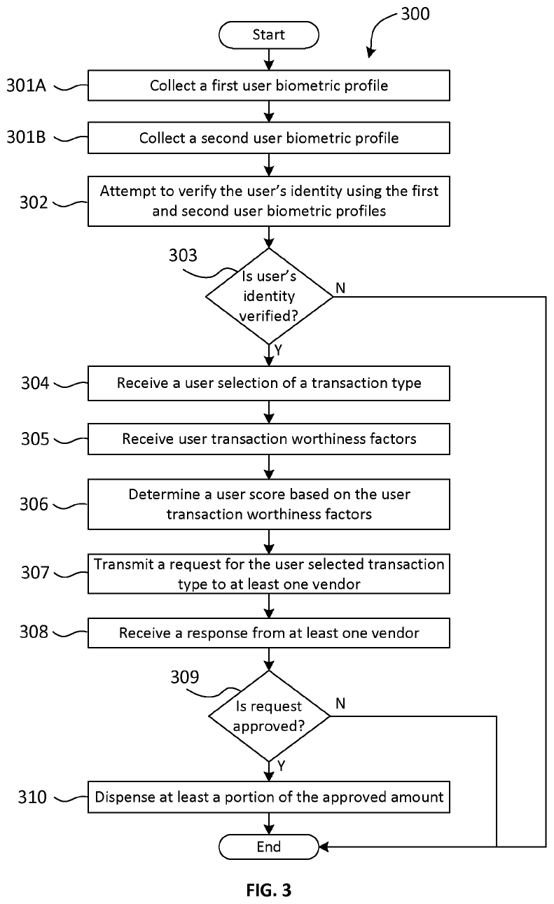

FIG. 3 is a flowchart of another example method 300 at the self-service computing apparatus 100 according to some embodiments. In this example, the biometric input device 110 comprises a first biometric input device and a second biometric input device.

At block 301A, the self-service computing apparatus 100 collects a first user biometric profile via the first biometric input device. At block 301B, the self-service computing apparatus 100 collects a second user biometric profile via the second biometric input device. In some embodiments, the first user biometric profile comprises a first facial recognition profile and the second user biometric profile comprises a second facial recognition profile.

In some embodiments, the first facial recognition profile may be captured by scanning a user provided image via a scanning device. Instructions may be displayed to the user via the user interface 106 indicating suitable types of images the user may provide. In some embodiments, the user provided image is a government issued photo identification (ID) card. In some embodiments, the government issued photo ID card is a driver's license. In other embodiments, the government issued photo ID card may be one of a passport, a health care card, a national identity card, or any other government issued identification that features a photograph of the user. Once scanned, the first facial recognition profile may be stored in the memory 104.

In some embodiments, the second facial recognition profile may be captured by taking a photograph of the user via a camera. In some embodiments, the photograph is a high resolution photograph. The second facial recognition profile may be stored in in the memory 104.

At block 302, the self-service computing apparatus 100 attempts to verify the user's identity by determining whether the first facial recognition profile corresponds to the second facial recognition profile. If the first and second user facial recognition profiles correspond, the user's identity is verified (yes at block 303) and the user may proceed with selecting the transaction type as described below.

In some embodiments, if the first and second facial recognition profiles do not correspond, attempting to verify the user's identity further comprises collecting a third facial recognition profile. For example, a third facial recognition profile may be collected when the photograph captured by the camera is of poor quality. In some embodiments, the third facial recognition profile is captured by taking a new photograph of the user via the camera. The third facial recognition profile may be compared to the first facial recognition profile to determine if the first and third facial recognition profiles correspond. If the first and third facial recognition profiles correspond, the user's identity is verified (yes at block 303) and the user may proceed with selecting the transaction type as described below.

In some embodiments, if the first and second facial recognition profiles, or the first and third facial recognition profiles do not correspond, attempting to verify the user's identify further comprises comparing at least one of the first, second, and third user facial recognition profiles to at least one stored facial recognition profile in a database. In some embodiments, the second or third facial recognition profile, captured from the photographs taken by the camera, is compared to at least one stored facial recognition profile in the database. If either the first, second, or third facial recognition profile corresponds to a stored facial recognition profile in the database, the user's identity is verified (yes at block 303). In some embodiments, the database is located on a remote server and the processor 102 is in communication with the remote server via the communication network.

If none of the first, second, or third facial recognition profiles correspond to a stored facial recognition profile in the database, the user's identity is not verified (no at block 303) and the user session may be terminated.

In some embodiments, if the user cannot provide a user provided image, and if no biometric profile for the user corresponds to a stored biometric profile in the database, the user interface 106 may display instructions directing the user to visit a vendor in person and provide suitable forms of identification. The user session may then be terminated.

The steps at blocks 304 to 307 may be similar to those described at blocks 204 to 207 of FIG. 2. Generally, at block 304, the self-service computing apparatus 100 receives a user selection of the transaction type and, at block 305, receives a plurality of user transaction worthiness factors. At block 306, the self-service computing apparatus 100 determines a user score. At block 307, a request for the user selected transaction type is transmitted to at least one vendor, the request including the user score.

At block 308, the self-service computing apparatus 100 may receive a response from at least one vendor, via the communication network, the response indicating that the user selected transaction type has been approved or denied. If the user selected transaction type has been approved (yes at block 309), the method 300 may continue to block 310. In some embodiments, the response indicating approval may further indicate an approved monetary amount of the approved transaction type. In some embodiments, the approved monetary amount may be the user requested monetary amount. In other embodiments, the approved monetary amount may be less than the user requested monetary amount. In some embodiments, the response indicating approval may further include additional information relevant to the user selected transaction type. For example, where the transaction type is issuing a credit product, the additional information may comprise at least one of an interest rate, a term, a total cost of the credit product, and any other relevant information.

If at least one response is received from at least one vendor indicating approval of the user selected transaction type, at least one transaction approval may be displayed to the user via the user interface 106. Each transaction approval displayed to the user may include the name of the vendor, the approved monetary amount, and any additional information relevant to the approved transaction type.

If the response from a given vendor indicates denial of the user selected transaction type (no at block 309), the method 300 may not proceed to block 310. In some embodiments, the response indicating denial may not be displayed to the user via the user interface 106.

In some embodiments, if the user selected transaction type is denied by all vendors to which the request was transmitted, the user interface 106 may display to the user that the request for the user selected transaction type has been denied. In some embodiments, the user interface 106 may prompt the user to select a different transaction type or a different amount of the user selected transaction type. In other embodiments, the user interface 106 may return to a main menu screen and/or the user session may be terminated.

In some embodiments, if at least one transaction approval is displayed to the user, a user selection may be received, via the user interface 106, of the approved transaction the user is desirous of acquiring. Terms and conditions for the user selected approved transaction may be displayed to the user via the user interface 106. In some embodiments, the terms and conditions are included in the response from the vendor indicating approval of the user selected transaction type. In other embodiments, the terms and conditions for at least one vendor are stored in memory 104 and displayed to the user when the user selects an approved transaction from that vendor. In some embodiments, if the user does not select at least one approved transaction, the user interface 106 may return to a main menu screen and/or the user session may be terminated.

In some embodiments, a user acceptance of the terms and conditions may be received from the user. In some embodiments, the user acceptance is received via the user interface 106. In other embodiments, at least one biometric device 110 comprises a fingerprint sensor and receiving the user acceptance of the terms and conditions comprises receiving at least one fingerprint of the user. In some embodiments, if the user acceptance is not received, the user interface 106 prompts the user to select a different approved transaction. In other embodiments, the user interface 106 may prompt the user to select a different transaction type or a different amount of the user selected transaction type. In other embodiments, the user interface 106 may return to a main menu screen and/or the user session may be terminated.

At block 310, the self-service computing apparatus dispenses at least a portion of the approved monetary amount of the approved transaction to the user. In some embodiments, a user selection is received, via the user interface 106, of the portion of the approved monetary amount the user wishes to be dispensed during the current user session. In some embodiments, the portion of the approved monetary amount is the entire approved monetary amount.

In some embodiments, a request for the user selected portion of the approved monetary amount is transmitted, via the communication network, to the vendor issuing the approved transaction. An electronic funds transfer may then be received, via the communication network, from the vendor for the user selected portion, thereby allowing the user selected portion to be dispensed at the self-service computing apparatus 100.

In some embodiments, the self-service computing apparatus 100 comprises a cash dispenser and dispensing the user selected portion of the approved monetary amount comprises dispensing cash. In some embodiments, the portion of the approved monetary amount is dispensed in at least one of banknotes and coins.

In other embodiments, dispensing the user selected portion of the approved monetary amount comprises effecting an electronic funds transfer to a user selected bank account. In some embodiments, the user bank account information is received and verified as described above. A request for the electronic funds transfer may be transmitted to the vendor that issued the approved transaction, the request including the user bank account information. The vendor may then transmit the electronic funds transfer directly to the user selected bank account.

In other embodiments, dispensing the user selected portion of the approved monetary amount comprises dispensing cryptocurrency to the user. In some embodiments, dispensing cryptocurrency to the user comprises displaying, via the user interface 106, a QR code encoding a value of cryptocurrency. In some embodiments, the self-service computing apparatus 100 comprises a printing device and dispensing the cryptocurrency comprises printing a QR code on a suitable medium. The QR code displayed via the user interface 106, or printed on the suitable medium, may be scannable by a QR reading application on the user's electronic device to transfer the value of cryptocurrency to a cryptocurrency wallet of the user.

In other embodiments, dispensing the user selected portion of the approved monetary amount comprises storing the user selected portion in an account accessible to the user by a mobile application.

In other embodiments, the self-service computing apparatus 100 comprises a card dispenser and dispensing the user selected portion of the approved monetary amount comprises dispensing a payment card to the user encoded with the user selected portion of the approved monetary amount. In some embodiments, the payment card may be associated with a unique identifier, for example, a unique card number. The unique card number may be stored as part of the user's profile. In some embodiments, at least one additional monetary amount may be transferred to the same payment card upon receiving at least one user request, via the user interface 106, for the additional monetary amount. The request for the additional amount may be received in one or more subsequent user sessions at the self-service computing apparatus 100.

In some embodiments, the self-service computing apparatus 100 comprises at least one payment device and may receive a payment from the user to repay at least a portion of the approved monetary amount to the vendor that issued the approved transaction. For example, a payment may be received to repay at least a portion of a credit product issued by a lending institution. In some embodiments, the payment may be received from at least one of a user debit card and a user credit card. In some embodiments, the payment may be received in cash. In some embodiments, the payment may be received by reading a QR code or a bar code displayed on the user's electronic device. An electronic funds transfer may then be transmitted, via the communication network, to transfer an amount equal to the received payment to the lending institution.

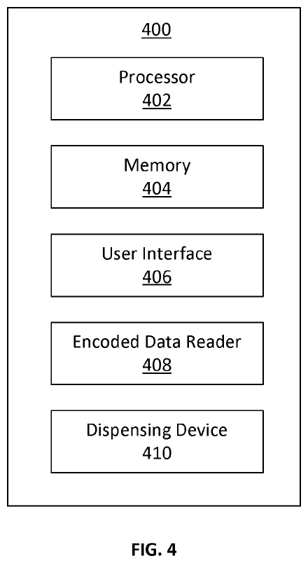

FIG. 4 shows a block diagram of another example self-service computing apparatus 400 that may implement embodiments of the methods described herein. The apparatus 400 includes a processor 402, a memory 404, a user interface 406, an encoded data reader 408, and a dispensing device 410.

The processor 402, the memory 404, and the user interface 406, may be similar to the processor 102, the memory 104, and the user interface 106, respectively, in FIG. 1 as described above.

At least one encoded data reader 408 may be configured to read at least one format of encoded data. For example, the encoded data reader may be configured to read at least one of a Radio-Frequency Identification (RFID) tag and a bar code. The encoded data reader 408 may be operatively connected to the processor 402 and the processor 402 may be configured to receive and process encoded data from the encoded data reader 408. In some embodiments, at least one encoded data reader 408 comprises a RFID reader. In some embodiments, at least one encoded data reader 408 comprises a bar code reader.

The dispensing device 410 may be configured to dispense a monetary amount to the user. The dispensing device 410 may be similar to the optional dispensing device of the self-service computing apparatus 100 described above.

Optionally, the self-service computing apparatus 400 further comprises at least one biometric input device and a verification module (not shown). The biometric input device and the verification module may be similar to the biometric input device 110 and the verification module 112 in FIG. 1 as described above.

Optionally, the self-service computing apparatus 400 comprises a transceiver (not shown). The transceiver may be similar to transceiver 108 in FIG. 1.

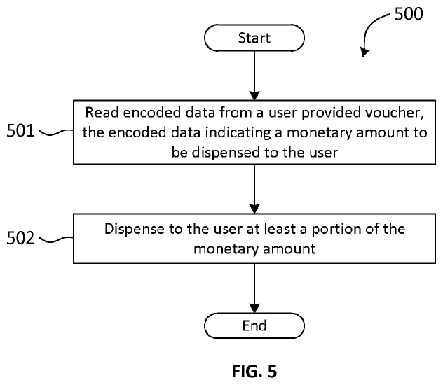

FIG. 5 is a flowchart of an example method 500 that may be performed at the self-service computing apparatus 400 for dispensing a payment from a payer.

In some embodiments, the payer issues a voucher to a payee for the payment. In some embodiments, the payee is an employee and the payer is an employer and the voucher is issued by the employer for at least a portion of the employee's wage. For example, the voucher may be issued by the employer for the employee's daily earnings. In other embodiments, the payee is a recycler who has deposited a quantity of recyclable material to a recycling facility, and the voucher is issued by the recycling facility to the recycler for the value of the recyclable material. For example, the voucher may be issued by a bottle depot for the value of a quantity of bottles and other recyclable beverage containers submitted by the recycler. In some embodiments, the voucher is in the form of a printed receipt. In other embodiments, the voucher is in the form of a card, for example a smart card or a chip card. In other embodiments, the voucher is stored electronically on a user electronic device, for example, a user smartphone or tablet. In some embodiments, the voucher may be stored on a user's electronic device in a mobile application.

In this embodiment, the user of the self-service computing apparatus 400 is a payee possessing at least one voucher for a payment.

The user may engage the self-service computing apparatus 400 to start a new user session. In some embodiments, if the user is a new user, the user is prompted via the user interface 406 to select a user name and a password. In some embodiments, if the user is a returning user, the user is prompted to enter their selected user name and password. In some embodiments, the user's identity is verified using at least one biometric profile as described above.

At block 501 of FIG. 5, the self-service computing apparatus 400 reads encoded data from a user provided voucher, the encoded data indicating the monetary amount to be dispensed to the user. Instructions may be displayed to the user via the user interface 406 indicating suitable formats of encoded data that the user may provide. In some embodiments, the encoded data comprises an RFID tag. In some embodiments, the RFID tag is in the form of an RFID card. In some embodiments, the encoded data comprises a bar code. In some embodiments, the bar code is displayed on the user's electronic device. In other embodiments, the bar code is on a printed receipt. In other embodiments, the encoded data comprises any form of encoded data suitable to be read by the encoded data reader 408.

At block 502, the self-service computing apparatus 400 dispenses at least a portion of the monetary amount to the user via dispensing device 410.

In some embodiments, dispensing device 410 is a cash dispenser and dispensing at least a portion of the monetary amount comprises dispensing cash to the user. In some embodiments, at least a portion of the monetary amount is dispensed to the user in at least one of banknotes and coins.

In other embodiments, dispensing at least a portion of the monetary amount comprises effecting an electronic funds transfer to a user selected bank account as described above.

In other embodiments, dispensing at least a portion of the monetary amount comprises dispensing cryptocurrency to the user. Dispensing the cryptocurrency to the user may be similar to that described above with respect to the self-service computing apparatus 100.

In other embodiments, dispensing at least a portion of the monetary amount comprises storing the portion in an account accessible to the user by a mobile application.

In other embodiments, the dispensing device 410 comprises a card dispenser and dispensing the user selected portion of the approved monetary amount comprises dispensing a payment card to the user encoded with the user selected portion of the approved monetary amount. Dispensing the payment card to the user may be similar to that described above with respect to the self-service computing apparatus 100.

In some embodiments, prior to dispensing at least a portion of the monetary amount, a user selection is received, via the user interface 406, of the portion of the monetary amount the user wishes to be dispensed during the current user session. In some embodiments, the portion of the monetary amount is the entire monetary amount of the payment.

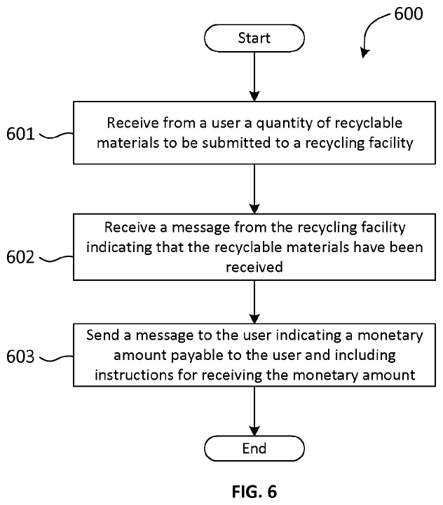

FIG. 6 is a flowchart of an example method 600 for administering an exchange of recyclable material for the value of the recyclable material, according to some embodiments.

The method 600 of FIG. 6 may be performed at a self-service computing apparatus comprising a processor, a memory, a user interface, and a transceiver. The processor, the memory, the user interface, and the transceiver may be similar to the processor 102, the memory 104, the user interface 106, and the transceiver 108 in FIG. 1 as described above.

Optionally, the self-service computing apparatus in this embodiment comprises at least one biometric input device and a verification module. The biometric input device and the verification module may be similar to the biometric input device 110 and the verification module 112 in FIG. 1.

Optionally, the self-service computing apparatus in this embodiment comprises a dispensing device. The dispensing device may be similar to the optional dispensing device of the self-service computing apparatus 100 of FIG. 1 and dispensing device 410 of FIG. 4 as described above.

Optionally, the self-service computing apparatus in this embodiment further comprises a printing device for printing a receipt for the user. In some embodiments, the printing device is a label printer for printing the receipt in the form of a label.

The user in this example is a recycler possessing recyclable material to be submitted to a recycling facility. For example, the user may possess bottles or other recyclable beverage containers to be submitted to a bottle depot. As another example, the user may possess deposit-bearing recyclables, for which a deposit was paid at the time of purchase, to be submitted to a recycling facility for re-payment of the deposit.

The user may engage the self-service computing apparatus to start a new user session. In some embodiments, if the user is a new user, the user is prompted via the user interface to select a user name and a password. In some embodiments, if the user is a returning user, the user is prompted to enter their selected user name and password. In some embodiments, the user's identity is verified using at least one biometric profile as described above.

At block 601 of FIG. 6, the self-service computing apparatus receives, via the user interface, a quantity of the recyclable material to be submitted by the user to the recycling facility. In some embodiments, a plurality of recycling facilities is displayed to the user via the user interface and a user selection is received of the recycling facility to which the user wishes to submit the recyclable material.

In some embodiments, the self-service computing apparatus prints a receipt, via the printing device, indicating the quantity of recyclable material. In some embodiments, the receipt is printed on a label such that the label may be affixed to the user's bags or other containers containing the recyclable material.

In some embodiments, instructions are displayed to the user, via the user interface, directing the user to drop off the user's recyclable material at the recycling facility. In some embodiments, the instructions may include the location of a secure drop-off area. In some embodiments, the instructions may include a code or other access key for the user to access the secure drop-off area.

At block 602, the self-service computing apparatus receives, via the communication network, a message from the recycling facility indicating that the quantity of recyclable materials has been received by the recycling facility. In some embodiments, the message may further indicate the monetary amount payable to the user based on the value of the submitted recyclable material.

In other embodiments, the message may indicate a confirmed quantity of recyclable material, i.e. the quantity of recyclable material received and confirmed by the recycling facility. The self-service computing apparatus in this embodiment may calculate a monetary amount payable to the user based on the confirmed quantity of recyclable material. In some embodiments, an assigned value for each respective type of recyclable material is stored in the memory of the self-service computing apparatus and used to calculate the monetary amount payable to the user.

At block 603, the self-service computing apparatus may then transmit a message to the user, via the communication network, indicating the monetary amount payable to the user and including instructions for receiving the monetary amount. In some embodiments, the message is sent as a text message to a user mobile device. In some embodiments, the message is sent as an email to a user email account. In some embodiments, the message is sent through a mobile application on the user's mobile device. In some embodiments, the instructions for receiving the monetary amount may comprise instructing the user to return to the self-service computing apparatus to dispense the monetary amount. In other embodiments, the instructions may comprise instructing the user to visit the recycling facility, or another location, to receive the monetary amount.

In some embodiments, the self-service computing apparatus may dispense at least a portion of the monetary amount to the user. Dispensing at least a portion of the monetary amount to the user may be similar to any of the dispensing methods described above with respect to the self-service computing apparatuses 100 or 400.

In some embodiments, prior to dispensing at least a portion of the monetary amount, a user selection is received, via the user interface, of the portion of the monetary amount the user wishes to be dispensed during the current user session. In some embodiments, the portion of the monetary amount is the entire monetary amount payable to the user.

Methods at self-service computing apparatuses for effecting a purchase of one or more regulated products are also provided herein. As used herein, a “regulated product” refers to a product for which sales are restricted to individuals above an age threshold. The age threshold may be set by regulations in a given jurisdiction. For example, the age threshold may be set by regulations specific to a country, a province, or a state. In some embodiments, the regulated product comprises a gaming product. For example, the gaming product may be a lottery ticket, a ticket for a prize draw, a “scratch and win” ticket, or any other type of ticket for a prize-based competition. However, a person skilled in the art will recognize that any type of regulated product may be purchased using the methods disclosed herein and the disclosed methods are not limited by the type of regulated product to be purchased. Methods are also provided for administering a gaming product prize, including checking if a gaming product is a winning gaming product and dispensing at least a portion of a won amount.

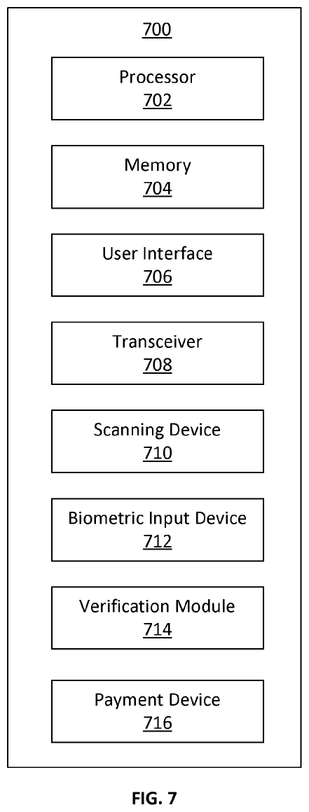

FIG. 7 is a block diagram of another example self-service computing apparatus 700 that may implement embodiments of the methods described herein. The apparatus 700 includes a processor 702, a memory 704, a user interface 706, a transceiver 708, a scanning device 710, a biometric input device 712, a verification module 714, and at least one payment device 716.

The processor 702, the memory 704, the user interface 706, and the transceiver 708 may be similar to the processor 102, the memory 104, the user interface 106, and the transceiver 108, respectively, in FIG. 1 as described above.

The scanning device 710 may be configured to scan at least one image from a government issued identification (ID) card. In some embodiments, the scanning device 710 may comprise an optical scanner, for example, a Contact Image Sensor (CIS) scanner. In other embodiments, the scanning device 710 comprises a card reader. The scanning device 710 may be operatively connected to the processor 702 and the processor 702 may be configured to receive and process data from the scanning device 710. The processor 702 may convert the image scanned by the scanning device 710 into digital data, for example, converting printed text in the image to digital text in order to capture a user's date of birth from the scanned government issued ID card. In some embodiments, the scanning device 710 is also configured to scan a regulated product such as a gaming product. For example, the scanning device 710 may scan a series of numbers on a lottery ticket.

At least one biometric input device 712 may be configured to collect at least one biometric profile. In some embodiments, the biometric input device 712 may be similar to the biometric input device 110 in FIG. 1 as described above. In some embodiments, the scanning device 710 may also function as a biometric input device by scanning an image from a user's government issued ID card to capture a facial recognition profile.

The verification module 714 may be configured to verify at least one of the user's purchase eligibility and the user's identity. The verification module 714 may verify the user's eligibility to purchase a regulated product based on the user's date of birth from the user's government issued identification card scanned by the scanning device 710. For example, the verification module 714 may verify the user's purchase eligibility by calculating the user's age based on their date of birth and comparing the user's age with an age threshold stored in the memory 704. In some embodiments, the verification module 714 may confirm the user's age by comparing the user's date of birth to a stored date of birth for that user in a database. The verification module 714 may verify the user's identity using at least one biometric profile collected by the biometric input device 712 in a similar manner to the verification module 112 in FIG. 1 as described above.

At least one payment device 716 may be configured to receive a payment from the user. The payment device 716 may be similar to the optional payment device described above with respect to the self-service computing apparatus 100. In some embodiments, at least one payment device 716 may comprise at least one encoded data reader. The encoded data reader may be similar to the encoded data reader 408 in FIG. 4 as described above.

Optionally, the self-service computing apparatus 700 further comprises a printing device for printing a receipt for the user.

Optionally, the self-service computing apparatus 700 further comprises a dispensing device. The dispensing device may be similar to the optional dispensing device of the self-service computing apparatus 100 of FIG. 1 as described above.

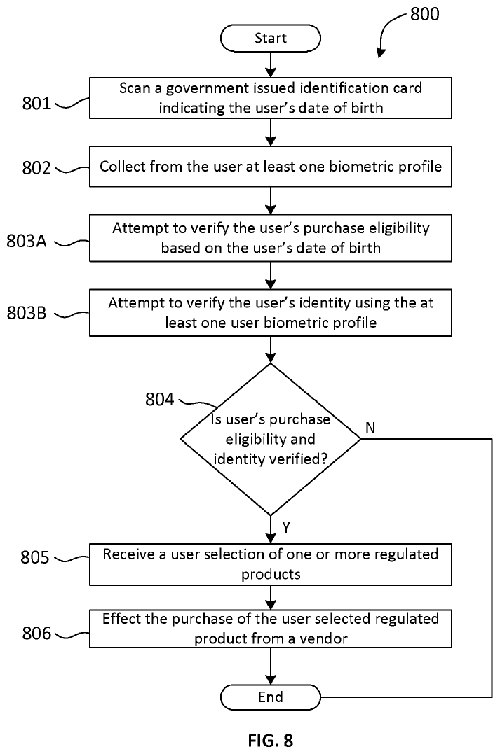

FIG. 8 is a flowchart of an example method 800 at the self-service computing apparatus 700 for purchasing one or more regulated products from a vendor, according to some embodiments.

In some embodiments, the vendor is a gaming authority. In other embodiments, the vendor is a licensed charity. In other embodiments, the vendor is any vendor offering one or more regulated products for purchase.

In this embodiment, the user of the self-service computing apparatus 700 is an individual desirous of purchasing one or more regulated products. The user may engage the self-service computing apparatus 700 to start a new user session. In some embodiments, if the user is a new user, the user is prompted via the user interface 706 to select a user name and a password. In some embodiments, if the user is a returning user, the user is prompted to enter their selected user name and password.

In FIG. 8, at block 801, the self-service computing apparatus 700 scans a government issued ID card of the user; the government issued ID card indicating the user's date of birth. Instructions may be displayed to the user via the user interface 706 indicating suitable types of government issued ID cards that may be scanned. In some embodiments, the government issued ID card is a driver's license. In other embodiments, the government issued ID card may be one of a passport, a health care card, a national identity card, or any other government issued identification that indicates the user's date of birth. In some embodiments, the government issued ID card is also a photo ID card featuring a photograph of the user.

A scanned image of the user's government issued ID card may be stored in the memory 704 and converted to digital data via the processor 702. The digital data may comprise the user's date of birth. Where the government issued ID card features of a photograph of the user, the digital data may further comprise an image of the user.

At block 802, the self-service computing apparatus 700 collects at least one biometric profile from the user. The steps at block 802 may be similar to the steps at block 201 of FIG. 2 or blocks 301A/301B of FIG. 3 as described above.

In some embodiments, the user biometric profile may comprise at least one of a facial recognition profile, a fingerprint, a palm print, a palm vein profile, an iris recognition profile, a retinal recognition profile, a voice recognition profile, a hand geometry profile, and combinations thereof.

In some embodiments, the facial recognition profile is collected from the user. In some embodiments, a first facial recognition profile is captured from the scanned image of the user from the user's government issued ID card. A second facial recognition profile may be captured by taking a photograph of the user via a camera.

At block 803A, the self-service computing apparatus 700 attempts to verify the user's purchase eligibility based on the user's date of birth. As used herein, “purchase eligibility” refers to the user being at or above an age threshold for regulated products in the jurisdiction in which the self-service computing apparatus 700 is located. The age threshold may be stored in the memory 704. The age of the user may be calculated based on the user's date of birth and the date of the current user session. The user's age may then be compared to the stored age threshold to verify the user's purchase eligibility. Alternatively, the memory 704 may store a date of birth threshold and the user's date of birth may be compared directly to date of birth threshold. The date of birth threshold may be updated daily to increase by one calendar day. In some embodiments, the self-service computing apparatus 700 may confirm the user's age by comparing the user's date of birth to a stored date of birth for that user in a database. In some embodiments, the database is located on a remote server and the processor 702 is in communication with the remote server via the communication network. In some embodiments, the self-service computing apparatus 700 makes an API call to the remote database.

At block 803B, the self-service computing apparatus 700 attempts to verify the user's identity using at least one biometric profile. The steps at block 803B may be similar to the steps block 202 of FIG. 2 or block 302 of FIG. 3 as described above. In some embodiments, attempting to verify the user's identity comprises determining whether the first facial recognition profile from the user's government issued ID card corresponds to the second facial recognition profile from the photograph of the user.

If the user's purchase eligibility and the user's identity are verified (yes at block 804), the user may proceed with selecting a regulated product as described below. If the user's purchase eligibility, the user's identity, or both, are not verified (no at block 804), the user session may be terminated and/or the user may be returned to a main menu screen.

In some embodiments, prior to terminating the user session, the self-service computing apparatus 700 may make one or more additional attempts to verify the user's purchase eligibility, the user's identity, or both. In some embodiments, the self-service computing apparatus 700 may make an additional attempt to verify the user's purchase eligibility by prompting the user, via the user interface 706, to re-scan their government issued ID card. In some embodiments, to make an additional attempt to verify the user's identity, a new photograph of the user may be captured by the camera in a similar manner as described above for block 303 of FIG. 3.

In the example method 800 shown in FIG. 8, the user's government issued ID card is scanned before collecting the user's biometric profile; however, in other embodiments, the user's biometric profile may be collected before scanning the user's government issued ID card.

In addition, in the example method 800 shown in FIG. 8, the user's purchase eligibility and the user's identity are verified before receiving a user selection of the regulated product; however, in other embodiments, the user selection is received before verification.

Other variations are also possible. In some embodiments, once the user's identity and purchase eligibility have been verified in a first user session; in subsequent sessions, the user's purchase eligibility may not need to be verified if the user enters the same user name and password and if their identity is verified as described above. Alternatively, for some regulated products, only the user's purchase eligibility may be verified and not the user's identity.

At block 805, the self-service computing apparatus 700 may receive, via the user interface 706, a user selection of one or more regulated products to be purchased. In some embodiments, the user interface 706 may display a plurality of regulated products to the user for selection. In some embodiments, the user interface 706 may display a plurality of vendors, each offering one or more regulated products for purchase. In some embodiments, where the user selected regulated product is a lottery ticket, the user interface 706 may prompt the user to enter a series of numbers to be used as the user's entry into the lottery. In some embodiments, a plurality of regulated products may selected by the user in the same user session.

At block 806, the self-service computing apparatus 700 may effect the purchase of the user selected regulated product(s) from a vendor.

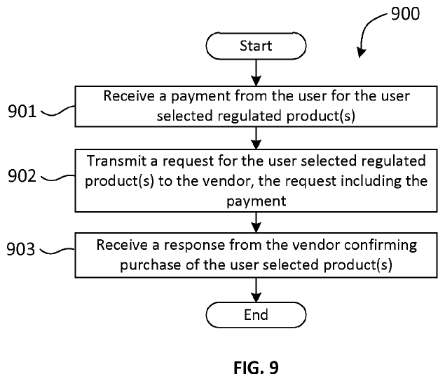

FIG. 9 is a flowchart of another example method 900 showing additional details regarding how the purchase of one or more user selected regulated products may be effected, according to some embodiments.

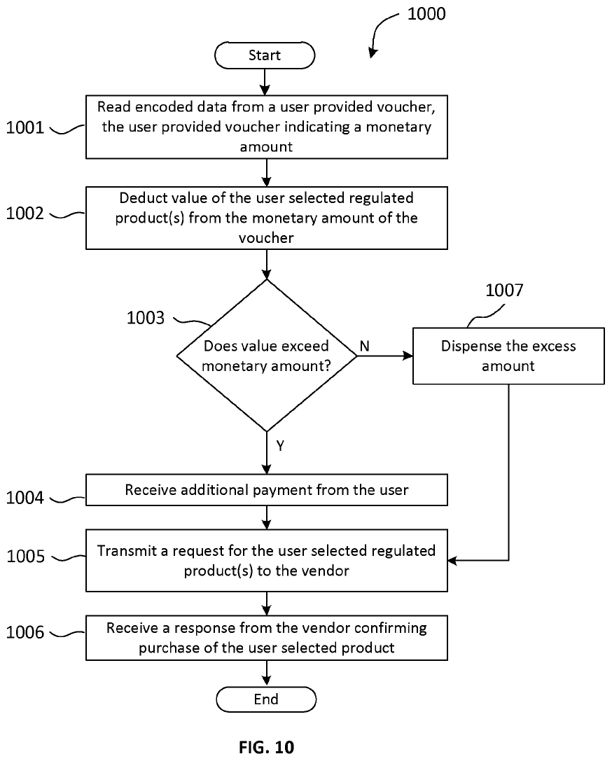

At block 901, a payment is received from the user for one or more user selected regulated products via at least one payment device 716. In some embodiments, at least one payment device 716 comprises a cash acceptor and the payment may be received in cash. In some embodiments, at least one payment device 716 comprises a card reader and the payment may be received from at least one of a user debit card and a user credit card through a POS (point of sale) transaction. In other embodiments, the payment may be received by any other suitable payment method, including from a user provided voucher as described in more detail below with respect to FIG. 10.

At block 902, the self-service computing apparatus 700 transmits a request for the user selected regulated product(s) to the vendor, via the communication network, the request including the payment. In some embodiments, the payment may be transmitted as an electronic funds transfer to the vendor. In some embodiments, the request is encrypted and an encrypted request is transmitted to the vendor.

At block 903, the self-service computing apparatus 700 may receive a response, via the communication network, from the vendor confirming purchase of the user selected regulated product(s). In some embodiments, the self-service computing apparatus 700 comprises a printing device and one or more user purchased regulated products are printed for the user. For example, a lottery ticket may be printed for the user. In other embodiments, one or more user purchased regulated products are sent to the user electronically, via the communication network. For example, a user purchased regulated product may be sent as a text message to a user mobile device, as an email to a user email account, or as a message in a mobile application on the user's mobile device.

FIG. 10 is a flowchart of another example method 1000 showing additional details regarding how the purchase of one or more user selected regulated products may be effected, according to some embodiments. In this embodiment, at least one payment device 716 comprises at least one encoded data reader.

At block 1001, at least one encoded data reader reads encoded data from a user provided voucher, the encoded data indicating a monetary amount. The user provided voucher may be similar to the user provided voucher described above with respect to the method 500 of FIG. 5. As one example, the user provided voucher may be issued by a recycling facility for the value of a quantity of bottles and/or other recyclable material submitted by a recycler.

In some embodiments, instructions may be displayed to the user via the user interface 706 indicating suitable formats of encoded data that the user may provide. In some embodiments, the encoded data comprises an RFID tag. In some embodiments, the RFID tag is in the form of an RFID card. In some embodiments, the encoded data comprises a bar code. In some embodiments, the bar code is displayed on the user's electronic device. In other embodiments, the bar code is on a printed receipt. In other embodiments, the encoded data comprises any form of encoded data suitable to be read by the encoded data reader.

At block 1002, the self-service computing apparatus 700 deducts the value of the user selected regulated product(s) from the monetary amount of the user provided voucher.

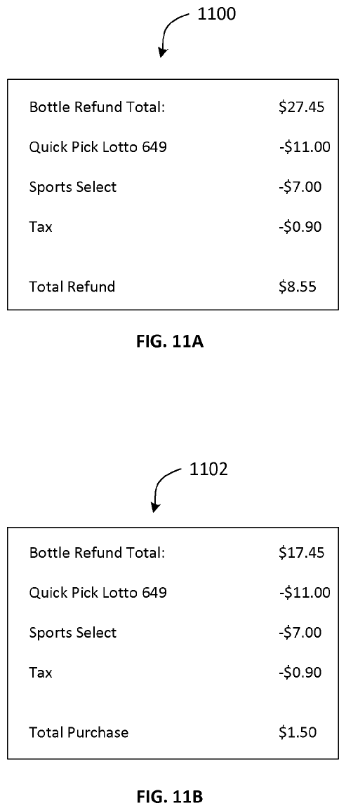

In some embodiments, the calculation deducting the value of the product(s) from the bottle return amount may be displayed to the user via the user interface 706. FIGS. 11A and 11B show two example screens 1100 and 1102 of the user interface 706 displaying calculations deducting the value of the user selected regulated products from the monetary amount of the voucher. In this example, the regulated products are lottery tickets and the voucher is from a bottle refund. In FIG. 11A, the value of the products is less than the bottle refund amount and the screen 1100 displays a total refund amount. In FIG. 11B, the value of the products is greater than the bottle refund amount and the screen 1102 displays a total purchase amount. The total purchase amount indicates the additional payment required from the user to effect the purchase.

If the value of the user selected regulated product(s) exceeds the monetary amount of the voucher (yes at block 1003), the self-service computing apparatus 700 may prompt the customer, via the user interface 706, to provide at least one additional payment method to pay for the remainder of the value of the product(s). In some embodiments, the user interface 706 may display two or more different payment method options to the user. For example, the payment method options may include payment with cash or payment with a user debit card and/or credit card. A user selection may then be received, via the user interface 706, of the payment method the user is desirous of providing.

At block 1004, an additional payment is received from the user via at least one payment device 716. In some embodiments, at least one payment device 716 comprises a cash acceptor and the additional payment may be received in cash. In some embodiments, at least one payment device 716 comprises a card reader and the additional payment may be received from at least one of a user debit card and a user credit card through a POS (point of sale) transaction. The method 1000 may then continue to block 1005 as discussed below.

In some embodiments, if the user is unable (or unwilling) to provide an additional payment, the user may be prompted, via the user interface 706, to change their selection of regulated product(s). A new user selection may then be received via the user interface 706. For example, the new user selection may include fewer regulated products and/or less expensive regulated products. In other embodiments, the user may be returned to a main menu screen and/or the current user session may be terminated.

If the value of the user selected regulated product(s) is less than the monetary amount of the voucher (no at block 1003), the self-service computing apparatus 700 may dispense the remaining monetary amount of the voucher (block 1007). The remaining monetary amount may be dispensed using any of the dispensing methods described herein. The method 1000 may then continue to block 1005.

At block 1005, the self-service computing apparatus 700 transmits a request for the user selected regulated product(s) to the vendor, via the communication network. The request may include the monetary amount received from the voucher and the additional payment (if required). The steps at block 1005 may be similar to the steps at block 902 described above.

At block 1006, the self-service computing apparatus 700 may receive a response, via the communication network, from the vendor confirming purchase of the user selected regulated product(s). The steps at block 1005 may be similar to the steps at block 903 described above.

In the example method 1000 shown in FIG. 10, the steps at block 1007 are performed before the steps at block 1005; however, in other embodiments, the steps at block 1007 may be performed after block 1005 or at any other suitable time before the current user session is ended.

In some embodiments, where the regulated product is a gaming product, the self-service computing apparatus 700 may also be used to administer a gaming product prize, including checking if a user purchased gaming product is a winning gaming product, and dispensing at least a portion of a won amount, as described in more detail below.

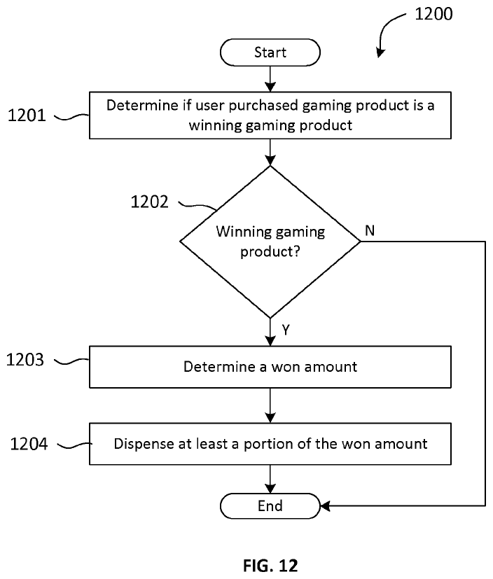

FIG. 12 is a flowchart of an example method 1200 showing additional steps for administering a gaming product prize. In this example, the gaming product is a lottery ticket and the prize is a monetary amount. However, it will be understood that similar steps can be used with respect to other types of gaming products and corresponding prizes.

A user having a user purchased gaming product may engage the self-service computing apparatus 700 to start a new user session. In some embodiments, if the user is a new user, the user is prompted via the user interface 706 to select a user name and a password. In some embodiments, if the user is a returning user, the user is prompted to enter their selected user name and password.

In some embodiments, the self-service computing apparatus 700 verifies the user's identity using any of the verification methods described above.

At block 1201, the self-service computing apparatus 700 determines if the user purchased gaming product is a winning gaming product. In this example, the user purchased gaming product is a user purchased lottery ticket; however, similar steps may be used with other types of gaming products. As used herein, “winning gaming product” may refer to any gaming product for which the purchaser is eligible to receive a prize including, for example, at least some monetary amount or some other prize (e.g. products, services, free plays, etc.).

In some embodiments, the self-service computing apparatus 700 may scan, via the scanning device 710, the user purchased lottery ticket. Scanning the user purchased lottery ticket may capture the user selected series of numbers used as the user's entry into the lottery. In other embodiments, the self-service computing apparatus 700 may receive from the user, via the user interface 706, the user selected series of numbers. In other embodiments, the user selected series of numbers are received from the user's electronic device, via the user interface 706, for example, via an RFID or NFC link.

The self-service computing apparatus 700 may then determine if the user selected numbers correspond to winning numbers. The term “correspond” in this context means that the user selected numbers match all or some of winning numbers such that the lottery ticket is eligible for at least some monetary amount or some other prize. In some embodiments, the winning numbers for a given lottery are stored in the memory 704 and the user selected numbers are compared to the stored winning numbers. In other embodiments, the self-service computing apparatus 700 transmits the user selected numbers to the vendor for the given lottery and receives a response from the vendor indicating if the user selected numbers correspond to winning numbers.

If the gaming product is determined to be a winning gaming product (yes at block 1202), then the method 1200 may proceed to block 1203 as described below. If the gaming product is determined to be a losing gaming product (no at block 1202), the user session may be terminated and/or the user may be returned to a main menu screen.

At block 1203, the self-service computing apparatus 700 determines a won amount of the winning gaming product. In some embodiments, the self-service computing apparatus 700 may calculate the won amount based on stored information in the memory 704. For example, the memory 704 may store information correlating a monetary amount with the number of user selected numbers that correspond to winning numbers. In other embodiments, the self-service computing apparatus 700 may receive a response from the vendor indicating the won amount, after the user selected numbers are transmitted to the vendor. In some embodiments, the user interface 706 may display to the user the won amount.

At block 1204, the self-service computing apparatus 700 may dispense at least a portion of the won amount to the user. The portion of the won amount may be dispensed to the user using any of the dispensing methods described above.

In some embodiments, a user selection may be received, via the user interface 706, of the portion of the won amount the user wishes to be dispensed during the current user session. In some embodiments, the portion of the won amount dispensed to the user is the entire won amount. In other embodiments, the portion of the won amount is a maximum portion of the won amount that can be dispensed to the user at the self-service computing apparatus 700. The maximum portion may be set be the vendor and may be stored in the memory 704.

In other embodiments, the steps at block 1204 may be omitted and instead of dispensing a won amount, the user interface 706 may display to the user alternative instructions for how to redeem their winning gaming product or the self-service computing apparatus 700 may transmit a message to the user's electronic device with such instructions. Such embodiments may be particularly suitable, for example, when the prize is a product or service rather than a monetary prize.

Therefore, embodiments of the methods described herein allow users to conduct a wide variety of transactions at self-service computing apparatuses 100, 400 and 700. In some embodiments, the methods described herein allow users to conduct a complete transaction at self-service computing apparatuses 100, 400 and 700. In some embodiments, methods at self-service computing apparatuses 100, 400 and 700 further enhance the security of the transaction by verifying the user's identity using at least one biometric profile. In some embodiments, the methods described herein also allow regulated products to be purchased from self-service computing apparatuses by verifying the user's purchase eligibility.

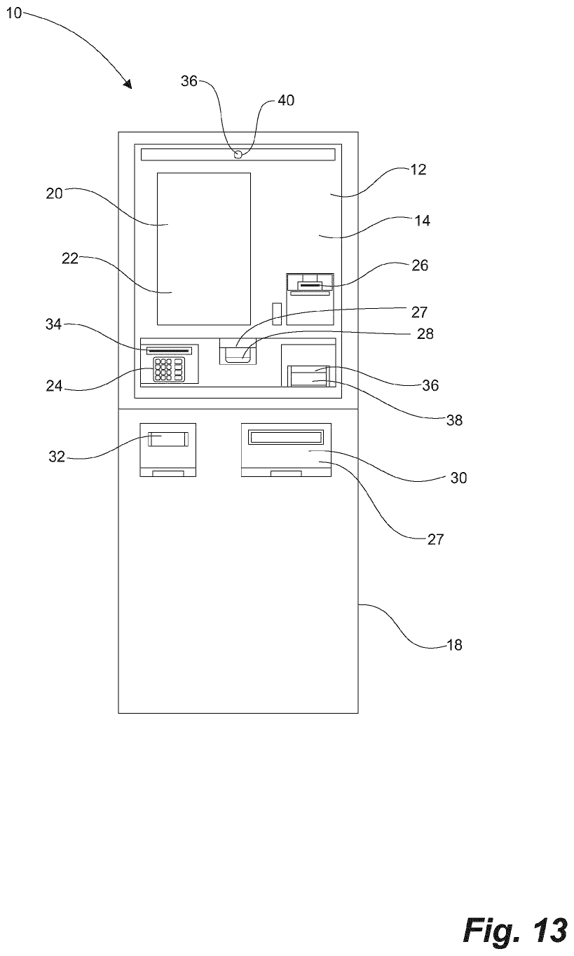

An example of a self-service computing device 10 that may implement the methods described herein will be described with reference to FIGS. 13-16. The self-service computing apparatus 10 is shown with specific components for implementing features similar to those of self-service computing apparatuses 100, 400, and 700 as shown in FIGS. 1, 4, and 7 respectively, and may perform the methods 200, 300, 500, 600, 800, 900, 1000, 1200 of FIGS. 2, 3, 5, 6, 8, 9, 10, and 12. It is to be understood that the self-service computing apparatus 10 is shown with very specific details for example purposes only.

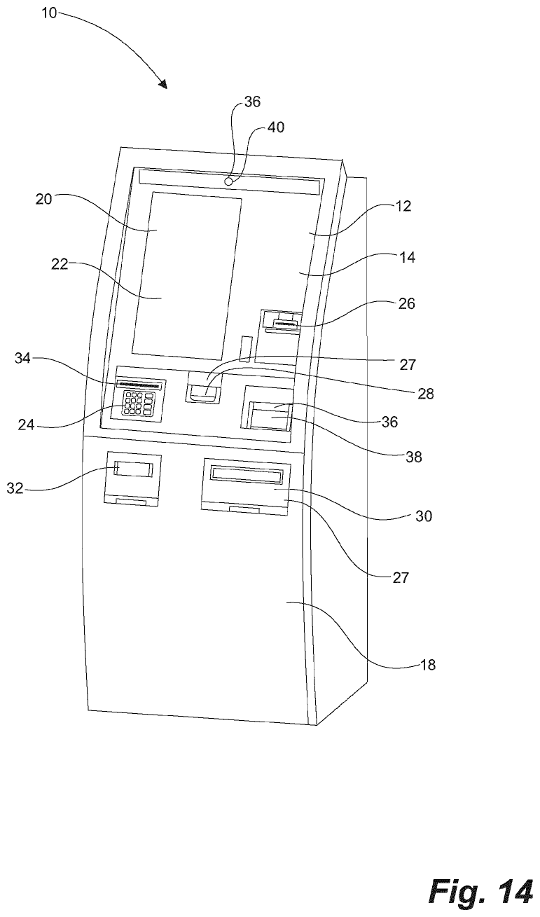

Referring to FIGS. 13 and 14, the self-service computing apparatus 10 may comprise an outer housing 12. In some embodiments, the outer housing 12 is a safe. In some embodiments, the outer housing 12 is a safe that meets the Underwriters Laboratories standard for a UL 291 Business Hours safe. The outer housing 12 may be any suitable size and shape. In some embodiments, the outer housing 12 is approximately the same size and shape as a conventional automated teller machine (ATM).

The outer housing 12 may comprise an upper section 14 and a lower section 18. At least one of the upper section 14 and the lower section 18 may comprise a locking mechanism (not shown) to prevent access to the interior of the outer housing 12 by unauthorized users.

The self-service computing apparatus 10 may comprise a user interface 20 to display information to the user and receive user input. In some embodiments, the user interface 20 comprises a touchscreen 22. In some embodiments, the user interface 20 further comprises a keypad 24.

The self-service computing apparatus 10 may comprise a card reader 26. In some embodiments, the card reader 26 is a magnetic card reader to read a magnetic stripe card, for example, a debit card or a credit card. In some embodiments, the card reader 26 may be configured for contactless payment using at least one of a RFID and NFC link. In some embodiments, the self-service computing apparatus 10 may further comprise a banknote acceptor 32 to accept banknotes from the user.

In some embodiments, the self-service computing apparatus 10 comprises a printer 34 to print, for example, a receipt or a label for the user.

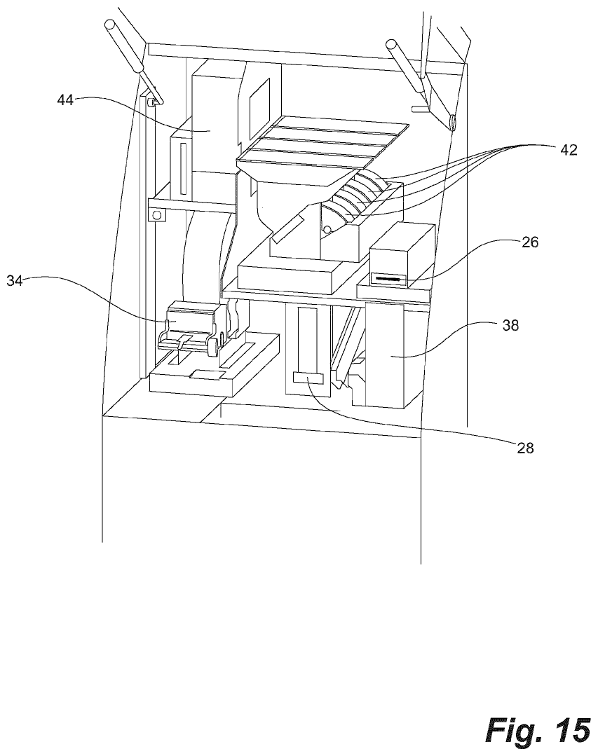

The self-service computing apparatus 10 may comprise at least one cash dispenser 27. At least one cash dispenser 27 may comprise a coin dispenser 28. As shown in FIG. 15, the coin dispenser 28 may comprise at least one coin hopper 42. Each coin hopper 42 may be configured to dispense at least one coin denomination. In the embodiment shown in FIG. 15, the coin dispenser 28 is a four-hopper coin dispenser.

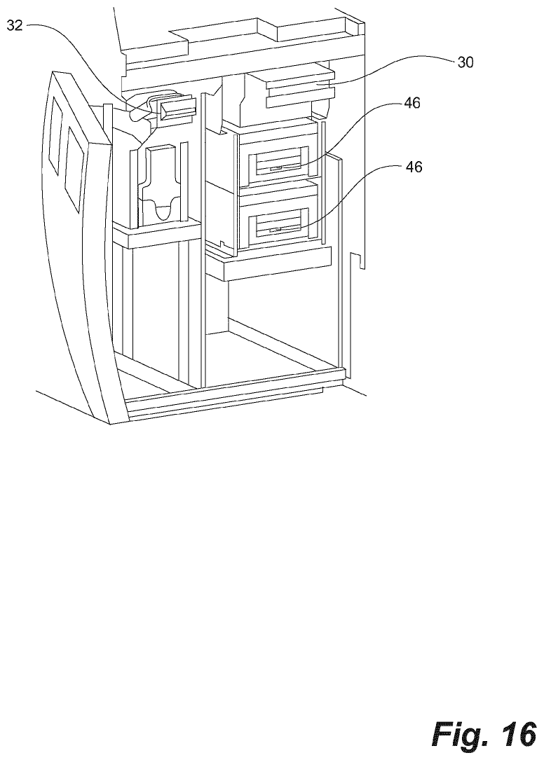

At least one cash dispenser 27 may comprise a banknote dispenser 30. As shown in FIG. 16, the banknote dispenser 30 may comprise at least one banknote cassette 46. Each banknote cassette 46 may be configured to dispense at least one banknote denomination.

As shown in FIGS. 14 and 14, the self-service computing apparatus 10 may comprise at least one biometric input device 36. In some embodiments, at least one biometric input device 36 may comprise a scanning device 38. In some embodiments, at least one biometric input device 36 may comprise a camera 40. In some embodiments, the camera 40 is a high definition camera.

As shown in FIG. 15, a processor 44 may be housed within the outer housing 12 of the self-service computing apparatus 10. The processor 44 may be in communication with the user interface 20 such that the processor 44 may receive input from the user via the user interface 20 and display output to the user via the user interface 20. In some embodiments, the processor 44 is in communication with at least one biometric input device 36 and the processor 44 is configured to receive and process biometric data from at least one biometric input device 36. In some embodiments, the processor 44 is operatively connected to a computer memory (not shown). In some embodiments, the computer memory is at least one of a primary storage and a secondary storage.

Various modifications besides those already described are possible without departing from the inventive concepts herein. The inventive subject matter, therefore, is not to be restricted except in the scope of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Although particular embodiments have been shown and described, it will be appreciated by those skilled in the art that various changes and modifications might be made without departing from the scope of the disclosure. The terms and expressions used in the preceding specification have been used herein as terms of description and not of limitation, and there is no intention in the use of such terms and expressions of excluding equivalents of the features shown and described or portions thereof.

1. A method at a self-service computing apparatus comprising a user interface and at least one biometric input device; the method comprising:
collecting from a user, via the at least one biometric input device, at least one user biometric profile;
attempting to verify the user's identity using the at least one user biometric profile;
upon successful verification, receiving from the user, via the user interface:
a user selection of a transaction type;
a plurality of user transaction worthiness factors;
determining a user score by assigning a point value to each one of the plurality of user transaction worthiness factors based on a comparison of the each one of the plurality of user transaction worthiness factors to a respective transaction worthiness criterion; and
transmitting a request for the user selected transaction type to at least one vendor via a communication network, the request including the user score.

2. The method of claim 1, wherein attempting to verify the user's identity using the at least one biometric profile comprises determining whether the at least one user biometric profile corresponds to at least one stored user biometric profile in a database.

3. (canceled)

4. The method of claim 2, wherein the at least one user biometric profile comprises at least one of: a facial recognition profile, a fingerprint, a palm print, a palm vein profile, an iris recognition profile, a retinal recognition profile, a voice recognition profile, a hand geometry profile, and combinations thereof.

5. The method of claim 1, wherein the at least one biometric device comprises a first biometric device and a second biometric device and collecting the at least one user biometric profile comprises collecting a first user biometric profile and a second user biometric profile.

6. The method of claim 5, wherein the first biometric device comprises a scanning device and collecting the first biometric profile comprises scanning a user provided image, via the scanning device, to capture a first facial recognition profile.

7. (canceled)

8. The method of claim 6, wherein the second biometric device comprises a camera and collecting the second biometric profile comprises capturing a second facial recognition profile of the user via the camera.

9. The method of claim 1, further comprising receiving a response from the at least one vendor via the communication network, the response indicating that the user selected transaction type has been approved or denied.

10. The method of claim 9, wherein receiving a response from the at least one vendor comprises receiving a respective response from at least two vendors, each respective response indicating that the user selected transaction type has been approved.

11. (canceled)

12. The method of claim 9, wherein the response indicates that the user selected transaction type has been approved and the response further indicates an approved monetary amount.

13. The method of claim 12, further comprising dispensing at least a portion of the approved monetary amount to the user.

14. The method of claim 13, wherein the self-service computing apparatus comprises a cash dispenser and dispensing the at least a portion of the approved monetary amount to the user comprises dispensing cash to the user via the cash dispenser.

15. The method of claim 13, wherein dispensing the at least a portion of the approved monetary amount to the user comprises effecting an electronic funds transfer to a user selected bank account, dispensing cryptocurrency to the user, or storing the at least a portion of the approved monetary amount in an account accessible to the user by a mobile application.

16-21. (canceled)

22. A method at a self-service computing apparatus comprising a user interface; the method comprising:
receiving from a user, via the user interface, a quantity of recyclable material to be submitted by the user to a recycling facility;
receiving a message from the recycling facility via a communication network, the message indicating that the quantity of recyclable material has been received by the recycling facility; and
sending a message to the user, via the communication network, the message indicating a monetary amount payable the user based on the quantity of recyclable material received by the recycling facility, the message including instructions for receiving the monetary amount.

23. The method of claim 22, wherein the self-service computing apparatus comprises a printing device and further comprising printing a receipt indicating the quantity of recyclable material to be submitted by the user to the recycling facility.

24. The method of claim 22, further comprising dispensing at least a portion of the monetary amount to the user.

25. A method at a self-service computing apparatus comprising a scanning device, at least one biometric input device, and a user interface, the method comprising:
scanning, via the scanning device, a government issued identification card of a user, the government issued identification card indicating the user's date of birth;
collecting from the user, via the at least one biometric device, at least one biometric profile;
attempting to verify at least one of:
the user's purchase eligibility based on the user's date of birth; and
the user's identity using the at least one biometric profile;
upon successful verification, receiving from the user, via the user interface, a user selection of one or more regulated products to be purchased; and
effecting the purchase of one or more user selected regulated products from a vendor.

26. The method of claim 25, wherein the self-service computing apparatus comprises at least one payment device and wherein effecting the purchase of the one or more user selected regulated products comprises:
receiving a payment from the user, via the at least one payment device, for the one or more user selected regulated products;
transmitting a request for the one or more user selected regulated products to the vendor, the request including the payment; and
receiving a response from the vendor confirming purchase of the one or more user selected regulated products.

27. The method of claim 26, wherein the at least one payment device comprises at least one encoded data reader and receiving the payment comprises reading, via the at least one encoded data reader, encoded data from a user provided voucher, the encoded data indicating a monetary amount.

28. The method of claim 25, wherein the one or more regulated products is a gaming product and further comprising determining if a user purchased gaming product is a winning gaming product.

29. (canceled)

30. The method of claim 28, further comprising dispensing at least a portion of a won amount of the winning gaming product
